(19) United States
(12) Patent Application Publication
(10) Pub. No.: US 2016/0216434 A1
(43) Pub. Date: Jul. 28, 2016

(54) ELECTRONIC DEVICE BEING ABLE TO SHOW LIGHT GRAPHICS

(71) Applicant: Quanta Computer Inc., Taoyuan City (TW)

(72) Inventors: Yu-Liang SHIH, Taoyuan City (TW); Jung-Wen CHANG, Taoyuan City (TW); Yen-Chun CHOU, Taichung City (TW)

(73) Assignee: QUANTA COMPUTER INC., Taoyuan City (TW)

(21) Appl. No.: 14/687,446

(22) Filed: Apr. 15, 2015

(30) Foreign Application Priority Data
Jan. 26, 2015 (TW) 104102578

(51) Int. Cl. F21V 8/00; F21V 23/00

(52) U.S. Cl. CPC G02B 6/0076; G02B 6/0068; G02B 6/0083; G02B 6/0073; F21V 23/005; F21Y 2101/02

(57) ABSTRACT

An electronic device able to show light graphic includes a housing, plural light-transmissive plates stacked inside the housing, plural light sources disposed inside the housing, and a control unit disposed inside the housing. Each of the light-transmissive plates includes a light-incident surface, a light output surface and an optical pattern formed on the light output surface thereof. Projection zones of the light output surfaces to the light-transmissive region are overlapped. The light sources are respectively arranged for emitting lights towards the light-incident surfaces. The control unit is electrically connected to the light sources for controlling at least one of the light sources to emit lights towards the light-incident surface of the corresponding light-transmissive plate, so that the lights form a light graphic by the optical pattern of the corresponding light-transmissive plate, and the light graphic is shown on a light-transmissive region.

### RELATED APPLICATIONS

This application claims priority to Taiwan Application Serial Number 104102578, filed Jan. 26, 2015, which is herein incorporated by reference.

### BACKGROUND

1. Field of Disclosure

The present disclosure relates to an electronic device. More particularly, the present disclosure relates to an electronic device being able to show light graphics.

2. Description of Related Art

Generally, the operation panel of an electronic device is allowed to appear a plurality of indicating symbols being arranged abreast thereon. When emitting the indicating symbols with lights in turns, the respective indicating symbols can be shown on one region of the operation panel in accordance with one of the conditions of the electronic device. However, since only the indicating symbol corresponding to the respective condition will be shown thereon, the other indicating symbols not corresponding to the respective condition will not be shown on the operation panel, so that the other indicating symbols being not shown might occupy the most area of the operation panel.

### SUMMARY

One aspect of the disclosure is to provide an electronic device being able to show light graphic to solve the defects and inconvenience of the prior art.

For achieving the aforementioned object, according to one or more embodiments of this disclosure, the electronic device being able to show light graphic includes a housing, plural light-transmissive plates, plural light sources and a control unit. The housing has a light-transmissive region being defined on an outer surface of the housing. The light-transmissive plates are mutually stacked inside the housing. Each of the light-transmissive plates includes a light-incident surface, a light output surface and an optical pattern formed on the light output surface thereof, wherein projection zones of the light output surfaces of the light-transmissive plates to the light-transmissive region are overlapped with each other. The light sources are disposed inside the housing, respectively arranged for emitting light towards the light-incident surfaces of the light-transmissive plates. The control unit is disposed inside the housing, electrically connected to the light sources for controlling at least one of the light sources to emit light. At least one of the light sources emits light towards the light-incident surface of the corresponding light-transmissive plate, so that the light forms a light graphic by the optical pattern of the corresponding light-transmissive plate, and the light graphic is shown on the light-transmissive region.

Thus, comparing to the prior art, since the electronic device of the disclosure is able to show the respective light graphic in the corresponding condition on the same region so that the area of the housing for showing all of the light graphics can be saved, and the interference caused from the other indicating symbols not shown up can be decreased either so as to enhance vision and the convenience of use.

Furthermore, since a user does not need a display module for showing the respective light graphic in the corresponding condition on the same region of the electronic device, the disclosure can effectively reduce the manufacturing cost, and provide more available space of the electronic device.

It is to be understood that both the foregoing general description and the following detailed description are by examples, and are intended to provide further explanation of the disclosure as claimed.

### BRIEF DESCRIPTION OF THE DRAWINGS

The disclosure may be more fully understood by reading the following detailed description of the embodiment, with reference made to the accompanying drawings as follows:

FIG. 1 is a perspective view of an electronic device according to a first embodiment of the disclosure;

FIG. 2 is a side view of the electronic device according to the first embodiment of the disclosure;

FIGS. 3A-3B are two light graphics respectively shown on the surfaces of the housing of the electronic devices noticed from a viewing direction D of FIG. 2;

FIG. 4 is a block diagram of an electronic device according to a second embodiment of the disclosure;

FIGS. 5A-5C are light graphics respectively shown on the surfaces of the housing of the electronic devices according to a third embodiment of the disclosure;

FIG. 6 is a side view of the electronic device according to a fourth embodiment of the disclosure;

FIG. 7 is a perspective view of an electronic device according to a fifth embodiment of the disclosure; and

FIG. 8 is a side view of the electronic device according to a sixth embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the disclosure.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

### First Embodiment

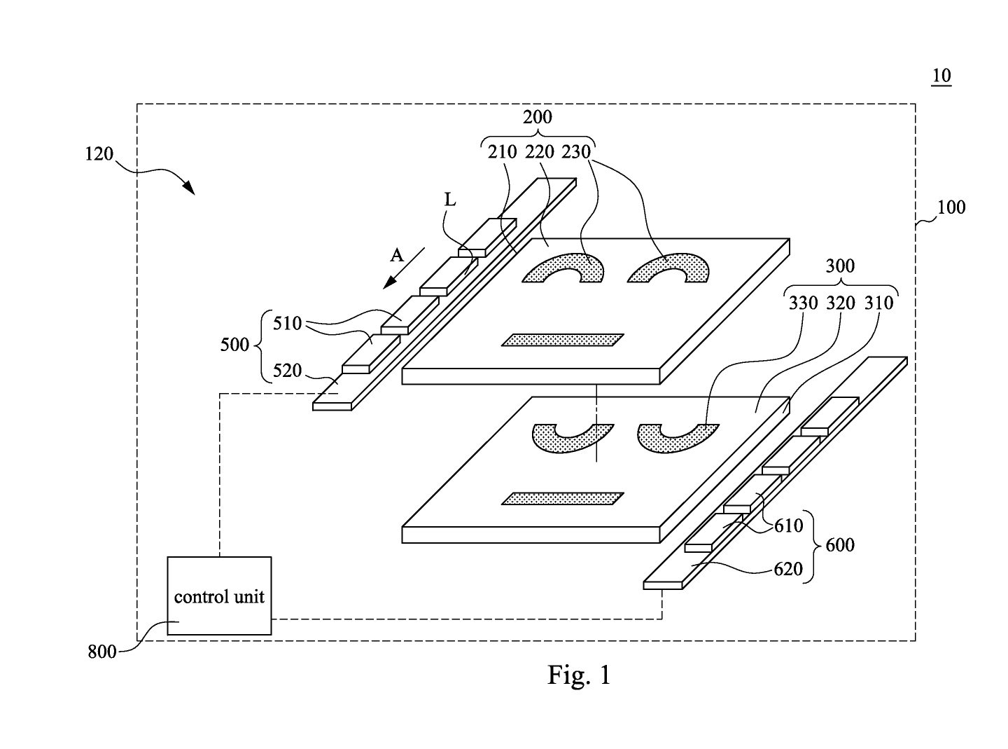

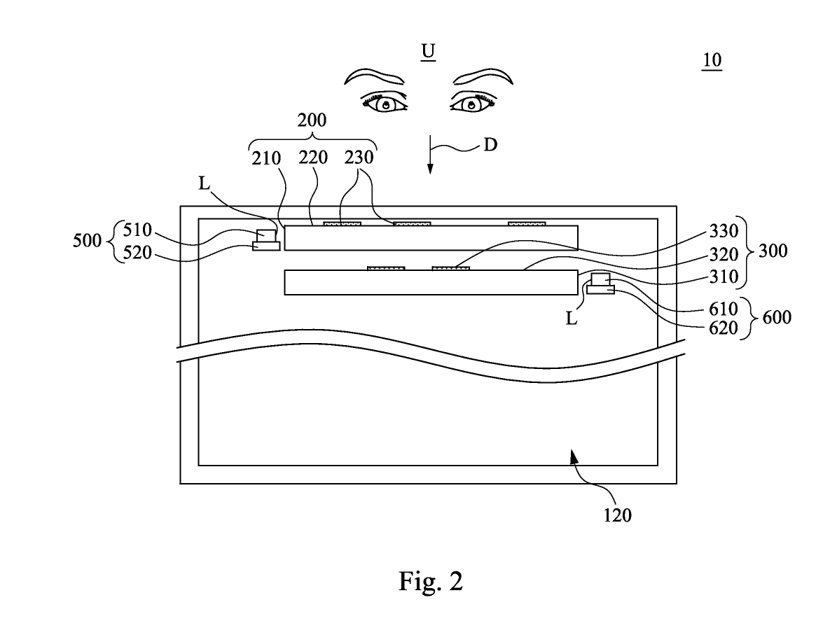

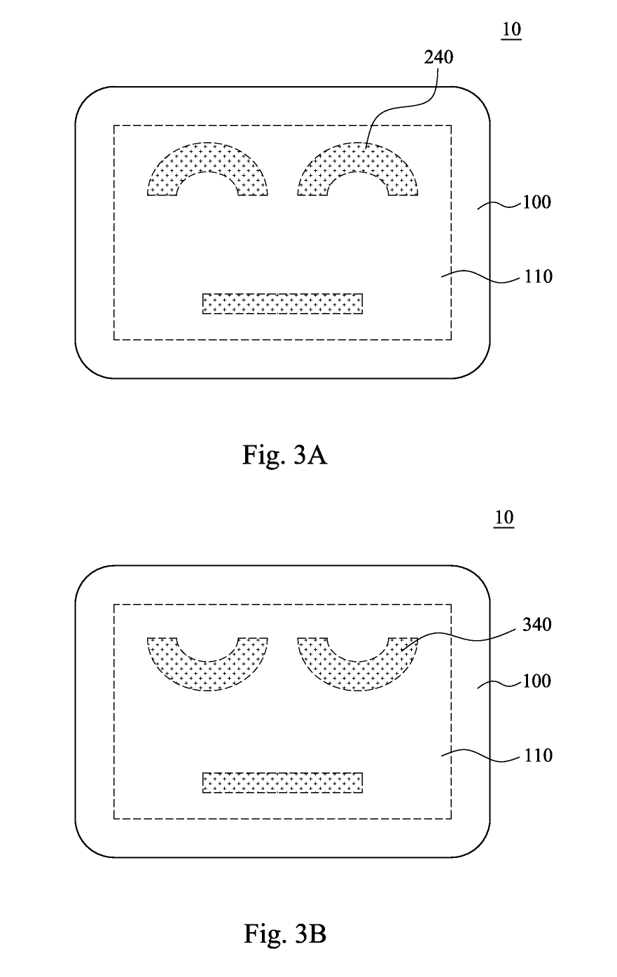

FIG. 1 is a perspective view of an electronic device 10 according to a first embodiment of the disclosure, and FIG. 2 is a side view of the electronic device 10 according to the first embodiment of the disclosure. As shown in FIG. 1 and FIG. 2, according to one or more embodiments of this disclosure, the electronic device 10 of the first embodiment includes a housing 100, a first light-transmissive plate 200, a second light-transmissive plate 300, a first light source 500, a second light source 600 and a control unit 800. The housing 100 is provided with a light-transmissive region 110 (refer to FIG. 3A) being defined on an outer surface of the housing 100. In this embodiment, the light-transmissive region 110, for example, can be a light-transmissive shield (or opening) capable of being transmitted by light. The housing 100 is provided with an accommodation space 120 therein. The first light-transmissive plate 200 and the second light-transmissive plate 300 are disposed in the accommodation space 120 of the housing 100, and the first light-transmissive plate 200 and the second light-transmissive plate 300 are mutually stacked with each other. The first light-transmissive plate 200 at least includes a first light-incident surface 210, a first light output surface 220 and at least one first optical pattern 230. The first optical pattern 230 is formed on the first light output surface 220. The second light-transmissive plate 300 at least includes a second light-incident surface 310, a second light output surface 320 and at least one second optical pattern 330. The second optical pattern 330 is formed on the second light output surface 320. The first light output surface 220 is arranged between the second light output surface 320 and the light-transmissive region 110, and the first light output surface 220 neighbors or contacts to the inner surface of the housing 100. The projection zone of the first light output surface 220 to the light-transmissive region 110 of the housing 100 and the projection zone of the second light output surface 320 to the light-transmissive region 110 of the housing 100 are overlapped with each other. The first light source 500 and the second light source 600 are disposed in the accommodation space 120 of the housing 100. In the specific embodiment, the first light source 500 is disposed on one side of the first light-transmissive plate 200, and faces towards the first light-incident surface 210 for emitting lights thereto; the second light source 600 is disposed on one side of the second light-transmissive plate 300, and faces towards the second light-incident surface 310 for emitting lights thereto. The control unit 800 is disposed in the accommodation space 120 of the housing 100 or in a main body of the housing 100, and the control unit 800 is electrically connected to the first light source 500 and the second light source 600. The control unit 800, for example can be a switch for outputting signals to control the first light source 500 or/and the second light source 600 to emit lights towards the first light-incident surface 210 or/and the second light-incident surface 310.

FIGS. 3A-3B are two light graphics respectively shown on the surfaces of the housing 100 noticed from a viewing direction D of FIG. 2. As shown in FIG. 1 and FIG. 3A, in the specific embodiment, in order to help an user of the electronic device 10 to be aware the condition of the electronic device 10 or the mood of the user, the control unit 800 is able to show the respective light graphic in the corresponding condition on the same region of the light-transmissive region 110. For example, when the control unit 800 is aware that electronic device 10 is under a first condition, the control unit 800 disables the second light source 600, and solely enables the first light source 500 to emit light towards the first light-incident surface 210 so that the light of the first light source 500 guided by the first light-transmissive plate 200 can be outwardly output from the first light output surface 220. Thus, the light of the first light source 500 form a first light graphic 240 (as the smile face in FIG. 3A) by the first optical pattern 230. Since the first light graphic 240 can be shown on the light-transmissive region 110 of the housing 100, the user U can see the first light graphic 240 through the light-transmissive region 110 of the housing 100.

In contrast, as shown in FIG. 1 and FIG. 3B, when the control unit 800 is aware that electronic device 10 is under a second condition, the control unit 800 disables the first light source 500, and solely enables the second light source 600 to emit light towards the second light-incident surface 310 so that the lights of the second light source 600 guided by the second light-transmissive plate 300 can be outputted outwardly from the second light output surface 320. Thus, the lights of the second light source 600 form a second light graphic 340 (as the sleeping face in FIG. 3B) by the second optical pattern 330. Since the second light graphic 340 can be shown on the light-transmissive region 110 of the housing 100 through the first light-transmissive plate 200, the user U can see the second light graphic 340 through the light-transmissive region 110 of the housing 100.

In the specific embodiment, as shown in FIG. 2, each of the first light-transmissive plate 200 and the second light-transmissive plate 300 is formed in a plate shape or a wedge shape, and each of the first light-transmissive plate 200 and the second light-transmissive plate 300 is provided with two opposite main surfaces and plural side surfaces mutually surrounding the opposite main surfaces in which each of the side surfaces is arranged between the opposite main surfaces, and the area of each of the side surfaces is less than the area of each of the opposite main surfaces. Any of the opposite main surfaces can be the aforementioned first light output surface 220 (or the second light output surface 320), and any of the side surfaces can be the aforementioned first light-incident surface 210 (or the light-incident surface 310). Furthermore, the first light-transmissive plate 200 and the second light-transmissive plate 300 are transparent material or at least translucent material, e.g., polycarbonate (PC), polyethylene methyl (i.e., acrylic), acrylonitrile-butadiene-styrene copolymer (i.e., ABS) and other plastic materials.

The aforementioned optical patterns (i.e., the first optical pattern 230 and the second optical pattern 330) are respectively formed on the corresponding light output surfaces (i.e., the first light output surface 220 and the second light output surface 320) mentioned above by any kind of surface treatment processes. Exemplarily, one of the surface treatment processes can be laser engraving technology, solution corrosion or alike. By forming dents or reflection points, the optical patterns are therefore relatively formed on the corresponding light output surfaces. Alternatively, the aforementioned optical patterns (i.e., the first optical pattern 230 and the second optical pattern 330) are formed on the corresponding light output surface (i.e., the first light output surface 220 and the second light output surface 320) mentioned above by a stuff-feeding process. For example, in one stuff-feeding process, reflective inks or particles can be applied on the corresponding light output surface to protrude over the plane of the light output surface.

Also, in one specific embodiment, each of the first light source 500 and the second light source 600 is a discontinuous light source. The discontinuous light source, for example, can be a point light bar, and the point light bar includes a plurality of light emitting diode elements 510 and a wiring board 520. The light emitting diode elements 510 are linearly arranged on the wiring board 520 in an arrangement direction A. The light emitting diode elements 510 are arranged at intervals on the wiring board 520 in an arrangement direction A. The emitting surfaces L of the light emitting diode elements 510 respectively output lights towards the corresponding the light-incident surface 210. Thus, since the light emitting diode elements 510 are independently electrically connected to the wiring board 520, thus, each of the light emitting diode elements 510 can be respectively controlled to be enabled, disabled or even adjusted in the light intensity by the control unit 800.

However, the disclosure is not limited thereto, that is, in other embodiments, each of the first light source and the second light source also can be a continuous light source, such as cool light strips. The cool light strips evenly emit lights towards the corresponding light-incident surface so as to evenly distribute the light intensity of the lights in the light-transmissive plate.

In addition, in one specific embodiment, the height (e.g., 0.6 mm) of the emitting surfaces L of the light emitting diode elements 510 or 610 is equal to or less than the height (e.g., 0.7 mm) of the light incident surface 210 or 310. Thus, it is advantageous to fully input the light of the light emitting diode elements into the corresponding light-transmissive plate so as to avoid from the waste of light energy. However, the disclosure is not limited thereto, that is, in other embodiments, the height of the emitting surfaces of the light emitting diode elements also can be greater than the height of the light incident surface to meet other restrictions or requirements.

Furthermore, in one better embodiment, a gap is kept between the first light-transmissive plate 200 and the second light-transmissive plate 300, for example, an air gap or an optical clear adhesive is directly sandwiched between the first light-transmissive plate 200 and the second light-transmissive plate 300 to isolate the first light-transmissive plate 200 and the second light-transmissive plate 300. Therefore, when the control unit 800 solely controls the second light source 600 to emits light to the second light indecent surface 310 only, since the gap is kept between the first light-transmissive plate 200 and the second light-transmissive plate 300, partial light of the second light source 600 will not be easier to get into the first light-transmissive plate 200 so that the second light graphic 340 will not be interfered by the glimmer first light graphic 240 so as to avoid from confusing the user.

However, the disclosure is not limited thereto, that is, in other embodiments, the first light-transmissive plate and the second light-transmissive plate also may be overlapped directly so that no gap is between the first light-transmissive plate and the second light-transmissive plate so as to avoid from decreasing the light intensity of the light getting into the first light-transmissive plate from the second light-transmissive plate.

### Second Embodiment

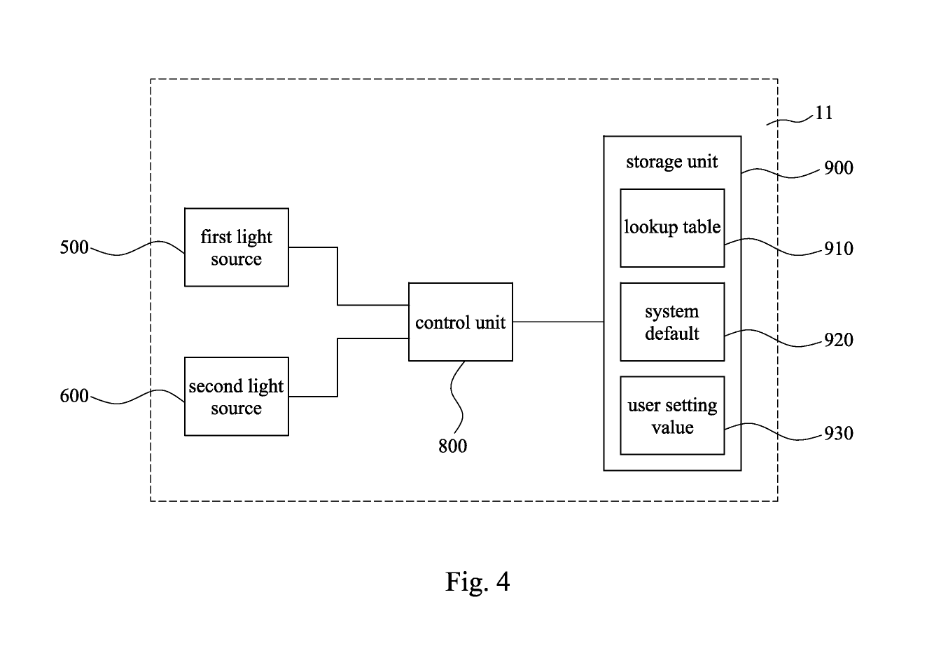

FIG. 4 is a block diagram of an electronic device 11 according to a second embodiment of the disclosure. As shown in FIG. 4, the electronic device 11 in the second embodiment is substantially the same as the electronic device 10 in the first embodiment except that the electronic device 11 of the second embodiment includes a storage unit 900 having a lookup table 910 therein, and the lookup table 910 includes various system conditions and various operation actions. Each of the system conditions corresponds to one or more specific operation actions. Thus, the control unit 800 finds out the corresponding operation actions from the lookup table 910 based on a system condition of the electronic device 11 to control the first light source 500 or/and the second light source 600 in operation (i.e., emitting, not emitting or adjusting the light intensity thereof). For an example, the control unit 800 is instructed to solely control one of the first light source 500 and the second light source 600 to emit light and to disable the other one of the first light source 500 and the second light source 600 according to one of the operation actions of the lookup table 910. Thus, any single light graphic representing one kind system condition can be solely shown on the same region of the light-transmissive region. Or, for another example, the control unit 800 also can be instructed to control both of the first light source 500 and the second light source 600 to emit lights at the same time according to another of the operation actions of the lookup table 910. Thus, by combining at least two of the light graphics, a new light graphic representing another kind of system condition can be therefore formed and shown on the same region of the light-transmissive region. Also, as another example, the control unit 800 also can be instructed to control all or part of the light emitting diode elements 510 and/or 610 of the light source 500 and/or 600 to emit or not emit according to one another operation action of the lookup table 910. Thus, by the combination of part of the light emitting diode elements 510 and/or 610 of the light source 500 and/or 600 emitting or being not emit, another new light graphic representing one another kind of system condition can be therefore formed and shown on the same region of the light-transmissive region. Furthermore, for still one another example, the control unit 800 also can be instructed to control light intensities of all or part of the light emitting diode elements 510 and/or 610 of the light source 500 and/or 600 to gradually increase (or decrease) in the arrangement direction A (FIG. 1) according to still one another operation action of the lookup table 910. Thus, the light graphic generates a multi-level color gradient effect to provide users an enhanced visual experience.

Furthermore, in this embodiment, the storage unit 900 is further provided with a system default 920 and a user setting value 930. The system default 920 indicates one of the operation actions corresponding to a system default mode in the lookup table 910. The user setting value 930 indicates another of the operation actions corresponding to a user setting mode in the lookup table 910. Therefore, when the electronic device 11 is set to the system default mode, according to the system default 920 from the lookup table 910, the control unit 800 matches the operation action corresponding to the system default mode for controlling the light source 500 and/or 600 in operation. On the other hand, when the electronic device 11 is set to the user setting mode, according to the user setting value 930 from the lookup table 910, the control unit 800 matches the operation action corresponding to the user setting mode for controlling the light source 500 and/or 600 in operation.

### Third Embodiment

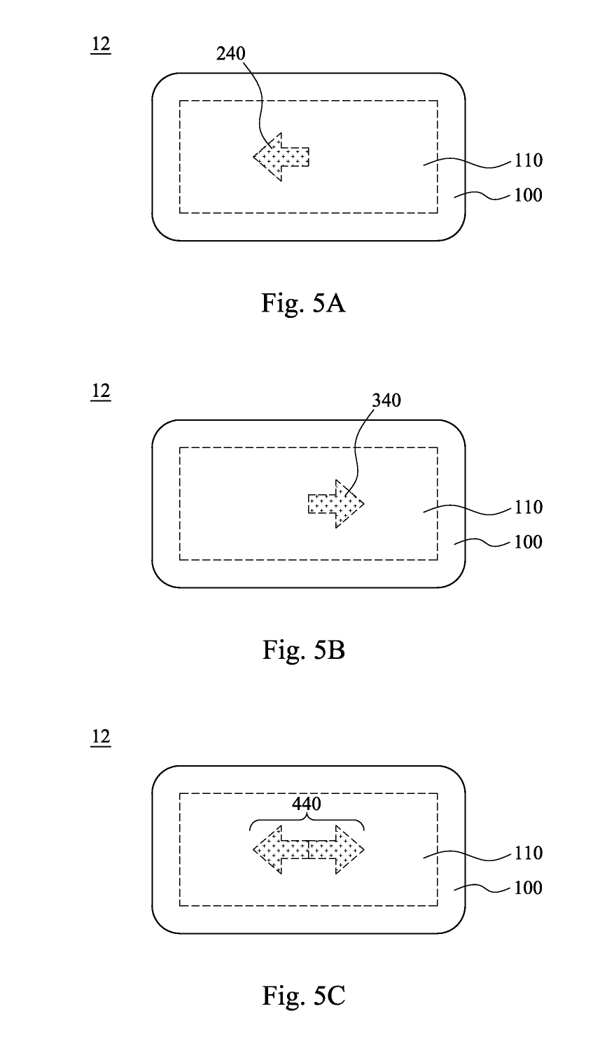

FIGS. 5A-5C are light graphics 240, 340, 440 respectively shown on the surfaces of the housing 100 of the electronic devices 12 according to a third embodiment of the disclosure. The electronic device 12 in the third embodiment is substantially the same as the electronic device 11 in the second embodiment except that the third light graphic 440 shown on the light-transmissive region 110 of FIG. 5C is formed by combining the first optical pattern (refer to the first light graphic 240 of FIG. 5A) and the second optical pattern (refer to the second light graphic 340 of FIG. 5B) when the control unit 800 is instructed to control both of the first light source 500 and second light source 600 to emit light at the same time.

Also, in one specific embodiment, the first light source 500 and second light source 600 are not limited to have to outwardly emit light in the same color (e.g., red, yellow, green or white). In this embodiment, the first light source 500 and second light source 600 also can respectively emit light outwardly in different colors. Exemplarily, the first light source 500 emits light with a first color, for example, the first light emitting diode elements 510 emits light with at least one type of color (e.g., red, yellow, green or white) so as to outwardly show the first light graphic 240 having the lights with the first color. The second light source 600 emits light with a second color different to the first color, for example, the second light emitting diode elements 610 emit light with at least one kind of colors (e.g., red, yellow, green or white) so as to outwardly show the second light graphic 340 having the light with the second color.

Moreover, when both of the first light source 500 and second light source 600 are controlled to emit light at the same time, the light with the first color from the first light source 500 and the light with the second color from the second light source 600 can mix into light with a third color so as to show the third light graphic 440 having light with the third color.

### Fourth Embodiment

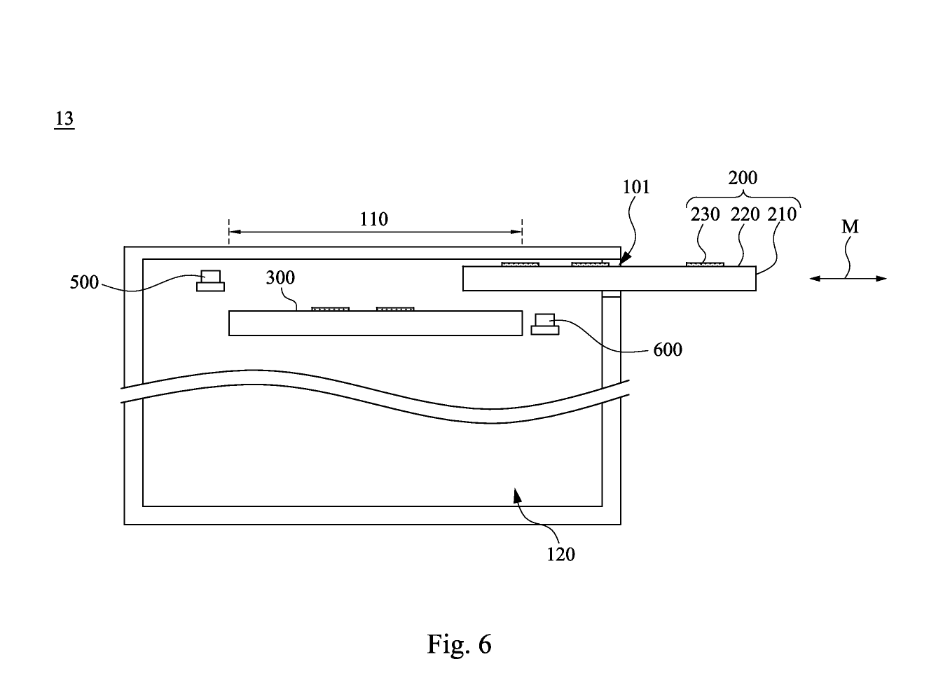

FIG. 6 is a side view of the electronic device 13 according to a fourth embodiment of the disclosure. As shown in FIG. 6, the electronic device 13 in the fourth embodiment is substantially the same as any of the electronic devices 10-12 in the above embodiments except that the first light-transmissive plate 200 or/and the second light-transmissive plate 300 is installed on the inner side of the housing 100, more particularly, the first light-transmissive plate 200 or/and the second light-transmissive plate 300 is replaceably disposed on the inner side of the housing 100. For example, since one side of the housing 100 is provided with an opening 101, thus, the first light-transmissive plate 200 can be inserted into the accommodation space 120 or drawn out of the accommodation space 120 from the opening 101 in a removing direction M so as to allow replacing with other different light-transmissive plate. Therefore, since the first light-transmissive plate 200 is replaceable by users, the first optical pattern 230 of the first light-transmissive plate 200 can be changed accordingly so that the different light graphic can be shown on the light-transmissive region 110 so as to enrich the experience of the users.

However, the disclosure is not limited thereto, that is, in other embodiments, the second light-transmissive plate, or both the first and second light-transmissive plates also can be replaceably disposed in the accommodation space of the housing.

### Fifth Embodiment

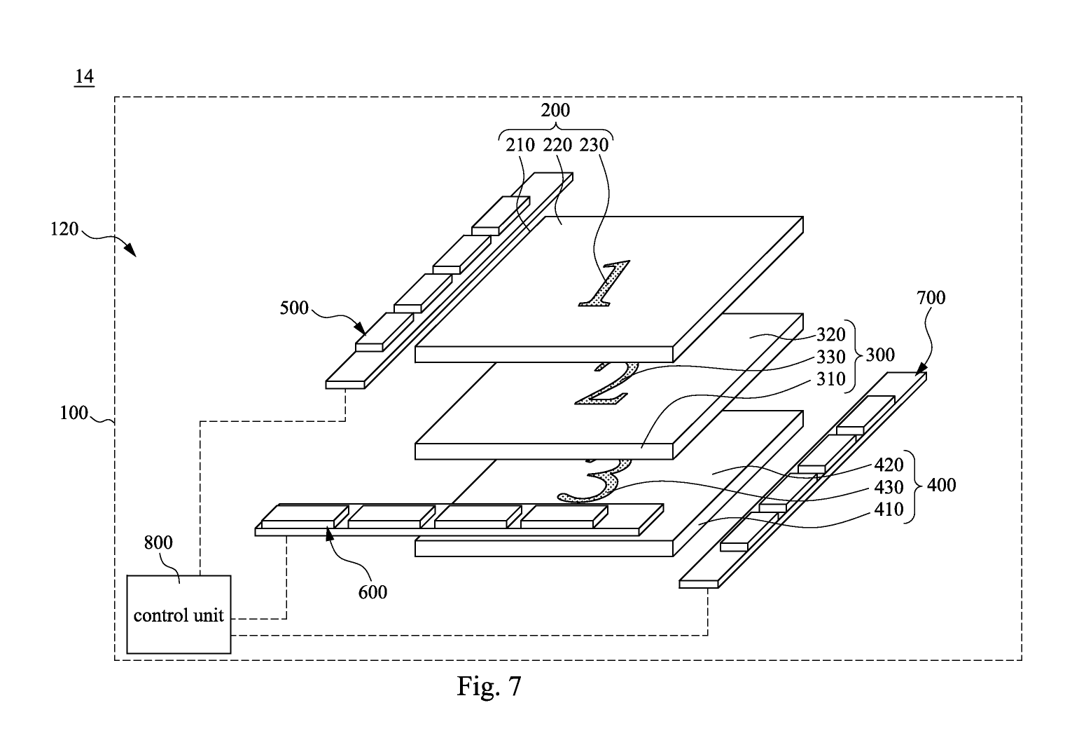

FIG. 7 is a perspective view of an electronic device 14 according to a fifth embodiment of the disclosure. As shown in FIG. 7, the electronic device 14 in the fifth embodiment is substantially the same as any of the electronic devices 10-13 in the above embodiments except that the electronic device 14 further comprises a third light-transmissive plate 400 and a third light source 700. The third light-transmissive plate 400 is disposed in the accommodation space 120 of the housing 100, and the first light-transmissive plate 200, the second light-transmissive plate 300 and the third light-transmissive plate 400 are stacked together. The third light-transmissive plate 400 at least includes a third light-incident surface 410, a third light output surface 420 and at least one third optical pattern 430. The third optical pattern 430 is formed on the third light output surface 420. The first light output surface 220 and the second light output surface 320 are disposed between the third light output surface 420 and the light-transmissive region 110 of the housing 100, and the projection zone of the first light output surface 220 on the surface of the housing 100 and the projection zone of the third light output surface 420 on the surface of the housing 100 are overlapped with each other. The third light source 700 is arranged in the accommodation space 120 of the housing 100, and the third light source 700 is disposed on one side of the third light-transmissive plate 400 and faces towards the third light-incident surface 410 for emitting lights thereto. The control unit 801 electrically connects the first light source 500, the second light source 600 and the third light source 700 for outputting signals to control a part or all of the first light source 500, the second light source 600 and the third light source 700 to emit lights towards the corresponding light-incident surface 210, 310 and 410. It is noted that the first light source 500, the second light source 600 and the third light source 700 are respectively disposed on the different sides of a stacking structure forming by stacking the first light-transmissive plate 200, the second light-transmissive plate 300 and the third light-transmissive plate 400 together, and the first light source 500, the second light source 600 and the third light source 700 respectively are not disposed on a same plane (e.g., a plane being orthogonal to a plumb direction)

However, the disclosure is not limited thereto, that is, in other embodiments, the first light source, the second light source and the third light source also can be disposed on the same side of the stack structure of the first light-transmissive plate, the second light-transmissive plate and the third light-transmissive plate.

### Sixth Embodiment

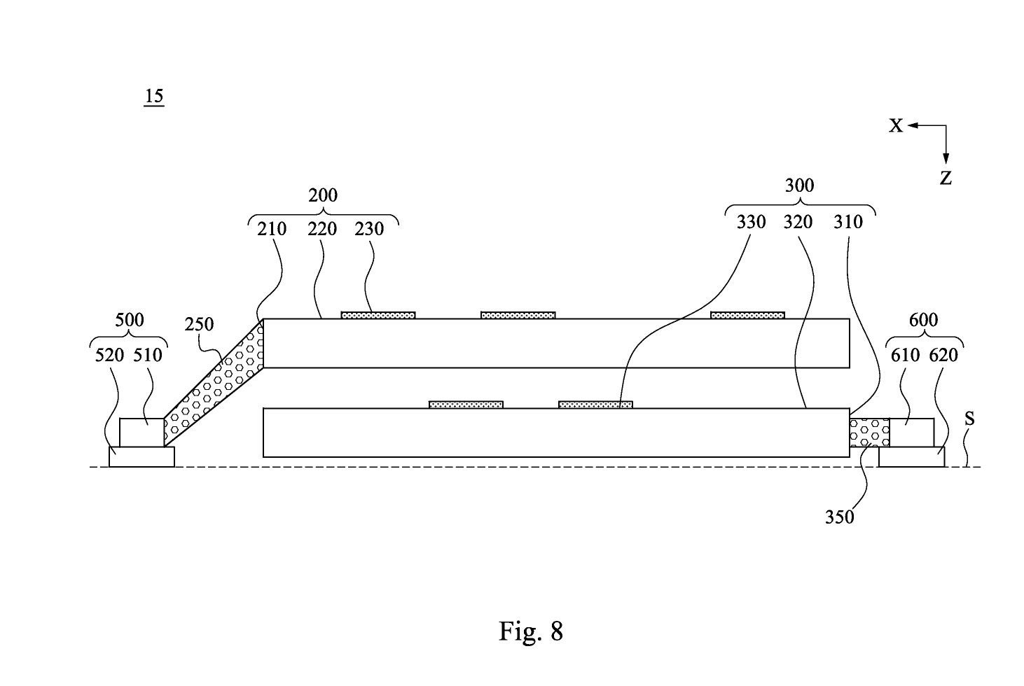

FIG. 8 is a side view of the electronic device 15 according to a sixth embodiment of the disclosure. As shown in FIG. 8, the electronic device 15 in the sixth embodiment is substantially the same as the electronic device 10 in the first embodiment except that the first light source 500 and the second light source 600 are disposed on the same plane S (e.g., a plane being orthogonal to a plumb direction, i.e., Z axis), and the electronic device 15 is provided with a first light guide member 250 and a second light guide member 350. The first light guide member 250 is optically coupled the first light-incident surface 210 and the emitting surface L of the first light emitting diode elements 510 of the first light source 500 for guiding the lights of the first light source 500 to the first light-incident surface 210. The second light guide member 350 is optically coupled the second light-incident surface 310 and the emitting surface L of the second light emitting diode elements 610 of the second light source 600 for guiding the lights of the second light source 600 to the second light-incident surface 310.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of the disclosure provided they fall within the scope of the following claims and their equivalents.

What is claimed is:

1. An electronic device being able to show light graphic, comprising:
a housing having a light-transmissive region being defined on an outer surface of the housing;
a plurality of light-transmissive plates mutually stacked inside the housing, and each of the light-transmissive plates comprising a light-incident surface, a light output surface and an optical pattern formed on the light output surface thereof, wherein projection zones of the light output surfaces of the light-transmissive plates to the light-transmissive region are overlapped with each other;
a plurality of light sources disposed inside the housing, respectively arranged for emitting lights towards the light-incident surfaces of the light-transmissive plates; and
a control unit disposed inside the housing, electrically connected to the light sources for controlling at least one of the light sources to emit lights,
wherein, the at least one of the light sources emits lights towards the light-incident surface of the corresponding light-transmissive plate, so that the lights form a light graphic by the optical pattern of the corresponding light-transmissive plate, and the light graphic is shown on the light-transmissive region.

2. The electronic device being able to show light graphic of claim 1, wherein the control unit is instructed to solely control one of the light sources to emit lights according to a lookup table.

3. The electronic device being able to show light graphic of claim 1, wherein the control unit is instructed to control at least two of the light sources to emit lights at the same time according to a lookup table.

4. The electronic device being able to show light graphic of claim 3, wherein the light graphic is formed by combining at least two of the optical patterns.

5. The electronic device being able to show light graphic of claim 1, wherein each of the light sources comprises a wiring board and a plurality of light emitting diode elements linearly arranged on the wiring board in an arrangement direction,
wherein the control unit controls light intensities of the light emitting diode elements to gradually increase in the arrangement direction.

6. The electronic device being able to show light graphic of claim 1, wherein the light sources respectively emit lights in different colors.

7. The electronic device being able to show light graphic of claim 1, wherein a spacer is disposed between every two neighboring ones of the light-transmissive plates.

8. The electronic device being able to show light graphic of claim 1, wherein each of the light sources is a continuous or discontinuous light source.

9. The electronic device being able to show light graphic of claim 1, wherein at least one of the light-transmissive plates is replaceably disposed on the housing.

10. The electronic device being able to show light graphic of claim 1, further comprising:
a plurality of light guide members respectively optically coupled the light-incident surfaces and the light sources.
